(19) United States
(12) Patent Application Publication
(10) Pub. No.: US 2007/0035196 A1
(43) Pub. Date: Feb. 15, 2007

(54) Composite electrical brush construction

(76) Inventor: David Hall Sidgwick, Sir Caerfyddin (Carms) (GB)

Correspondence Address: McCarter & English, LLP, Financial Centre, Suite 304A, 695 East Main Street, Stamford, CT, 06901-2138, US

(21) Appl. No.: 10/546,080

(22) PCT Filed: Feb. 13, 2004
(86) PCT No.: PCT/GB04/00590

§ 371 Date: Jun. 19, 2006

(30) Foreign Application Priority Data
Feb. 18, 2003 (GB) 0303752.0

(51) Int. Cl. H01R 39/36; H01R 39/24

(52) U.S. Cl. 310/249; 29/826; 29/879; 310/251

(57) ABSTRACT

A method of manufacturing a composite electrical brush (10) comprises forming a brush body part (14) of low resistivity, carbon/graphite/resin material; heat treating the formed body; applying a layer (34) of high resistivity, resin-containing material to a face (22) of the brush body part; and curing the high resistivity layer: preferably the high resistivity layer is a paste, is applied by roll coating, painting, screen printing or transfer printing and can be applied to a surface (28) of the brush body part other than a surface (20, 24) of the press-way direction: the thus-formed composite electrical brush has the high resistivity, graphite/resin layer (34) bonded to the back face (28 ) of the carbon/graphite/resin brush body part (14).

This invention relates to methods of manufacturing composite electrical brushes and to composite electrical brushes manufactured thereby. Electrical brushes are a conductor serving to provide, at a sliding (usually rotating) surface, electrical contact with a part moving relatively to the brush: for example, brushes are used in the transfer of electricity from and/or to slip rings or commutators in electrical machines.

### BACKGROUND

A composite electrical brush is a brush comprising two different materials laminated across the brush. Such brushes are sometimes referred to as sandwich brushes or bi-component brushes and give characteristics not achievable with a brush of uniform composition. The brush will usually have a flexible conductor or shunt (hereinafter “flex”), such as braided copper, located into one face of the brush to enable current transfer.

A major application of composite electrical brushes is in commutation influence, composite electrical brushes with two or more layers of distinguishably different materials will have hybrid contact drop characteristics; this can be used to influence commutation. Typically in composite electrical brushes, a high copper part is the major portion having. the properties of relatively low electrical resistivity and a low copper part is the minor portion having relatively high resistivity. The low copper part forms the tailing edge of the brush so that during the commutation process the tendency for a spark to be created between the trailing edge of the brush and the departing commutator segment is minimised. Such brushes are commonly but not exclusively used in applications where high currents are passed and electrical wear plays a significant part in he commutation process such as in permanent magnet geared starters.

Other reasons for laminating different materials across a brush include:
Friction stabilisation—the provision of differing frictional characteristics to the laminated materials to provide smoother running of the brush without the need to incorporate so-called “lubricator” brushes among the main brushes on a machine.
Collector skin control—the provision of abrasive layers to provide a cleaning action to remove skins of debris forming on the collector surface or between the conductors of a commutator.
Circulating current impedance—the suppression of parasitic currents traversing the brush face. Transformer action circulating currents can be set up in the brushes in some applications and the resistance at the bond between the two layers may help suppress these.

Typically, a composite electrical brush is made by adapting a standard press to take two filling shoes, one for each powder, and by modifying the stroke of the press to allow two filling actions. On occasion a pre-pressing compaction stroke, of a top tool, occurs between the two fillings. Finally the top tool and copper flexible is inserted into the die. The two powders are then pressed together and around the powders to make the final product. Alternately a pre-form, a pre-pressed piece of a single powder, may be inserted into the die. A second powder is added on top and the whole pressed, with copper flexible as described above. The brush is subsequently heat treated and finished. Typical finishing is to reduce the press-way direction to size, grind a radius on the running face and weld the flex, to prevent fraying and allow easy subsequent assembly. Because of the method of manufacture the thickness of the high resistivity part is typically 20% of the final brush thickness. Additionally, the choice of high resistivity material is limited to those that can be subjected to heat treatment required for the low resistivity main body part, typically 500° C., and the need to match thermal expansion coefficients so that the materials do not separate in heat treatment.

### PRIOR ART

Document GB-A-1509469 discloses a composite electrical brush with layers of graphited or ungraphited pyrolytic carbon attached to the body of a brush by an electrically conductive bond or depositing pyrolytic carbon on a face of the brush body from a vapour phase.

Document U.S. Pat No. 5,285,126 discloses a press-moulded, composite electrical brush having a body made of a first carbon piece, and a layer disposed on a side thereof made of a second, less conductive carbon piece; the second piece covering only a portion of the side of the blush.

### OBJECT OF THE INVENTION

It is an object of the present invention to provide an alternative and simpler method of manufacturing composite electrical brushes; which method, additionally, enables the manufacture of heretofore impossible composite-electrical brush designs.

The applicant has realised that as the composite electrical brush has to be finished i.e. to reduce the press-way thickness to size etc, then it is possible to add the high resistivity layer as part of the finishing process and after the heat treatment process. This means that a wider range of materials can be used for the high resistivity layer and composite electrical brushes can be pressed on a standard mono press (i.e. one with a single filling shoe) and have a high resistivity layer applied subsequently. By such a procedure the high resistivity layer may be thinner than hitherto which may extend the range of devices in which such brushes may be used and applied to other than press-way direction brush surfaces.

### STATEMENT OF INVENTION

Accordingly the present invention a method of manufacturing a composite electrical brush comprises the steps of:
forming a brush body part of low resistivity, carbon/graphite/resin material; heat treating the brush body part to carbonise the resin;
applying a layer of high resistivity, resin-containing material to a face of the brush body part; and;
curing the high resistivity layer to bond it to the brush body part.

In a preferred embodiment of the method of the present invention, the high resistivity, layer is a paste and may be applied by roll coating, painting, screen printing or transfer printing.

In an further embodiment of the method of the present invention, the brush body part is pressed and the high resistivity layer may be applied to a surface of the brush body part other than a surface of the press-way direction.

Also according to the present invention, a composite electrical brush comprises a high resistivity, graphite/resin layer bonded to a low resistivity, carbon/graphite/resin brush body part.

According to a preferred embodiment of the present invention, the thickness of the high resistivity, graphite/resin layer is less than 10% of the brush body part thickness.

According to another embodiment of the present invention, the brush body part is a pressing and the high resistivity layer is bonded to a surface of the brush body part other than a surface of the press-way direction.

By low resistivity is meant a material having a resistivity of less than 50 μΩ·m (microOhm·metre). By high resistivity is meant a material having a resistivity greater than 200 μΩ·m. In addition the ratio of high to low resistivity may vary from 4:1 upward.

### BRIEF DESCRIPTION OF DRAWING

The above and further features of the present invention are illustrated by way of example in the following description with reference to the drawing which is a perspective view of a composite electrical brush.

### DETAILED DESCRIPTION

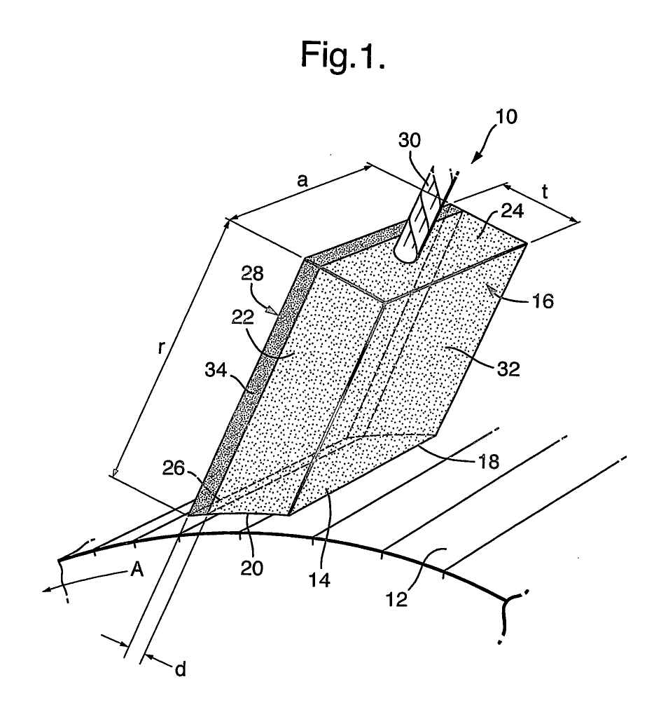

As shown by FIG. 1, a composite electrical blush 10 is shown contacting part of a commutator 12, the brush having a main body part 14 with a front face 16, an entering (leading) edge 18, a bevelled contact surface 20, a side face 22, a top surface 24, a leaving (trailing) edge 26, and a back face 28. A flex 30 is fitted into the top surface 24, is embedded in the brush body part and conducts current to/from the brush 10.

The brush 10 has a body main part 32 is of low resistivity material and a back layer 34 of high resistivity material.

With the brush 10 arranged as shown in the figure, with a clockwise rotating commutator 12 (in the direction of the arrow A), the high resistivity layer 34 extends over the whole of the back face 28 of the brush body and forms the trailing edge 26 for the brush. This suppresses the tendency of the brush to spark and hence reduces wear.

In alternative, unillustrated embodiments, the flex may enter the brush body through the front 16, side 22 or back 28 faces. Insertion of a flex through a back face with a low copper powder layer would cause an ageing problem (a diminution in electrical conductivity with time.) consequently, in such embodiments, the high resistivity layer extends over the bottom part only of the back face of the brush body and the flex passes through the back face and directly into the low resistivity main body part.

In all cases the high resistivity (low copper) layer forms the trailing edge of the brush so that, during the commutation process, the tendency for a spark to be created between the trailing edge and the previous commutator segment is minimised.

Usually, brushes are formed by a pressing operation wherein the flex is inserted in the press-way direction. However, for the composite brush configuration shown in the figure, the flex 30 enters the brush through the top surface 24 and extends substantially the length of the low resistivity body 32, and cannot be made with a pressed-in flex by prior art pressing techniques; so that a separate drilling and seculing step is required.

Typically a brush body main part 32 will be made of a carbon/graphite/resin material, which may contain copper or other metals. The other metals may be transition metals such as zinc, iron, chromium, manganese or alkaline earth metals such as bismuth. The resin may be phenolic or an epoxy resin.

In accordance with the present invention, the brush body main part 32 is pressed to shape in a filling shoe by pressure applied to the top surface 24 (the press-way direction) and may have a flex pressed-in at this stage. Typical pressures, depending upon brush cross-section, are in the range 140 to 420 mega Pascal. More accurately, for a pressed (green) density independent of cross-sectional area, but dependent upon copper percentage content and formulation, are in the range 21 to 90 mega Pascal.

After pressing, the brush body part will be heat treated, at a temperature of between 300° C. and 900° C., typically 500° C., to carbonise the resin. A gaseous atmosphere of either a neutral (e.g. Nitrogen, Argon or Helium), slightly oxidising (up to 5% Hydrogen in Nitrogen or exothermic gas) or reducing gas (endothermic gas or >20% Hydrogen in Nitrogen or Argon or other suitable neutral gas) may be used.

After heat treatment some degree of finishing will be required. This will usually include reducing the press-way dimension to within a specified tolerance by some grinding operation and often imparting a radius to the final contact face. A consolidation of the final few mm's of the copper flex may also be undertaken. It is during this sequence of operations that the layer 34 is coated onto the back brush face 28; i.e. it is applied to a surface 28 of the brush body part 14 other than a surface 24, 20 of the press-way direction.

The high resistivity layer 34 is applied to the brush body main part 32 where required and by any suitable means. For example, paste of a graphite/resin mixture (possibly with copper addition) can: be roll coated onto the back face of the brush body main part, followed by drying and Heat treatment, to a temperature of between 150 and 200 ° C., typically 180 ° C., to cure the resin. The high resistivity layer bonds to the brush back face 28, to ensure adhesion. Other methods that can be used to apply the high resistivity layer include painting, screen printing, transfer printing The high resistivity layer could be cured by ultra-violet or infra-red radiation The invention is not limited to any specific method of applying the high resistivity layer. The high resistivity paste may contain no copper or up to 20 % copper by weight and the ratio of graphite to resin binder may be of the order of 10:1.

The cured high resistivity layer forms a chemical bond with the brush main body part. The high resistivity layer may also form a mechanical bond or key with the back face of the brush body part and the surface of brush main body part may be machined to improve such a key; for example by surface roughening or tessellation or forming fine grooving lengthwise of the brush body. This surface machining conveniently forms part of the above-described finishing treatment. Alternatively, surface features could be formed as part of the pressing operation.

By adding the high resistivity layer during the finishing operation, the choice of material for this layer becomes wider since there is no thermal miss-match across and causing separation of the joint between the high resistivity layer and the brush body main part during the heat treatment process. The high resistivity material does not have to resist the high heat treatment temperatures. Additionally, adding the high resistivity layer to pressed-to-size brushes enables the manufacture of previously impossible designs of composite brush because the high resistivity layer is not a pressing. In the example, it will be seen that the high resistivity layer 34 has been applied to a surface 28 of the main brush body part 32 other than a surface 20, 24 of the press-way direction. Also, there need not be any moulding of the high resistivity layer after its application to the pressed and heat treated brush body.

### EXAMPLES

Examples of high resistivity paste:
A) 20 % copper powder plus 80 % pre-mixture (of molybdenum disulphide+graphite+phenolic resin) plus 15 % by wt of methyl ethyl ketone (any suitable solvent will do.
B) 58 % coarse flake graphite plus 3.9 % hardener plus 38.4 % pre-solvated epoxy resin (80 % solids in methyl ethyl ketone) ref MECL material E1491 .RH—obtainable from Morganite Electrical Carbon Limited 52 Clase Road, Morriston, Swansea SA6 8 PP, United Kingdom.

Test comparison of starter motor composite electrical brushes showed that a standard datum blush made by pressing two dissimilar powders together (ref MECL grade D12 ) gave a durability of 30,000 cycles while an alternative brush grade (ref MECL grade CM180 ) converted into composite form (ref brush material E1492 VH by adding a paste layer (ref MBCL experimental paste B) gave 20,000 cycles. This data proves that the addition of the paste layer provides a functional brush although, in the tested experimental sample, of lesser durability.

In exemplary brushes having a width (a) and thickness (t) of 5 mm and a length (r) of 20 mm or a width (a) of 20 mm, a thickness (t) of 10 mm and a length (r) of 30 mm; the high resistivity layer may have a thickness (d) of 0.5 mm ±0.3 mm, up to a maximum of 1.0 mm.

The present invention provides a simple and cost-effective method of producing composite electrical brushes wherein the thiclkness of the high resistivity layer can be controlled to thinner levels than with pressing, can be up to 10 % of the brush body thickness and can be applied to surfaces other than surfaces 20, 24 of the press-way direction. The criteria of the high resistivity layer are that it bonds to the brush body main part and that it impacts the correct electrical properties to the overall composite electrical brush.

1. A method of manufacturing a composite electrical brush (10) comprising the steps of:
forming a brush body part (14) of low resistivity material; and,
applying a high resistivity layer (34) to a face (28) of the brush body part;
characterised by the steps of:
forming the brush body part (14) of carbon/graphite/resin material;
heat treating the brush body part to carbonise the resin;
applying a high resistivity, graphite/resin material layer (34) to the face (28) of the heat treated brush body part; and;
curing the high resistivity layer to bond it to the brush body part.

2. A method as claimed in claim 1 and further characterised in that the high resistivity layer (34) is applied as a paste.

3. A method as claimed in claim 1 and further characterised in that the high resistivity layer (34) is applied by roll coating, painting, screen printing or transfer printing.

4. A method as claimed in claim 1 and further characterised by the step of pressing the brush body part (14).

5. A method as claimed in claim 4 and further characterised by the step of applying the high resistivity layer (34) to a surface (28) of the brush body part (14) other than a surface (20, 24) of the press-way direction.

6. A method as claimed in claim 4 and further characterised by the step of pressing a flex (30) into the brush body part (14) as it is formed.

7. A method as claimed in claim 1 and further characterised in that the low resistivity brush body part material contains a metal selected from the group comprising copper, zinc, iron, chromium, manganese, bismuth.

8. A method as claimed in claim 1 and further characterised in that at least one of the main body part resin and the high resistivity layer resin is phenolic or epoxy.

9. A method as claimed in claim 8 and further characterised in that the high resistivity layer material paste includes between 0 and 20% by weight of copper.

10. A method as claimed in claim 1 and further characterised in that the step of curing the high resistivity, graphite/resin material layer comprises drying and heating or irradiating with infra-red or ultra-violet radiation.

11. A method as claimed in claim 1 and further characterised in that the high resistivity layer (34) is bonded to the brush body part (14) by at least one of chemical bonding and mechanical bonding.

12. A method as claimed in claim 11 and further characterised by the step of machining or moulding the face (22) to provide a mechanical bond between the high resistivity layer (34) and the brush body part (14).

13. A composite electrical brush comprising a low resistivity body part (14) and a high resistivity layer (34) characterised in that a high resistivity, graphite/resin layer (34) is bonded to a low resistivity, carbon/graphite/resin brush body part (14).

14. A composite electrical brush, as claimed in claim 13 and further characterised in that the thickness (d) of the high resistivity, graphite/resin layer (34) is less than 10% of the thickness (t) of the brush body part (14).

15. A composite electrical brush, as claimed in claim 13 and further characterised in that the high resistivity, graphite/resin layer (34) is bonded to the low resistivity, carbon/graphite/resin brush body part (14) by at least one of chemical bonding and mechanical bonding.

16. A composite electrical brush as claimed in claim 13 and further characterised in that the brush body part (14) is a pressing and the high resistivity layer (34) is bonded to a surface (28) of the brush body part other than a surface (20, 24) of the press-way direction.
